(19) United States
(12) Patent Application Publication
(10) Pub. No.: US 2026/0353137 A1
(43) Pub. Date: Nov. 5, 2026

(54) METHOD FOR REPORTING AMPLITUDE COEFFICIENT, TERMINAL AND NETWORK DEVICE

(71) Applicant: Beijing Xiaomi Mobile Software Co., Ltd., Beijing (CN)

(72) Inventor: Mingju LI, Beijing (CN)

(73) Assignee: Beijing Xiaomi Mobile Software Co., Ltd., Beijing (CN)

(21) Appl. No.: 19/124,598

(22) PCT Filed: Oct. 27, 2022
(86) PCT No.: PCT/CN2022/128060

§ 371 Date: Apr. 25, 2025

(51) Int. Cl. H04W 24/10

(52) U.S. Cl. CPC H04W 24/10

(57) ABSTRACT

A method for reporting an amplitude coefficient, including: determining a target method for reporting the amplitude coefficient in a case where at least two methods for reporting the amplitude coefficient are supported; and reporting the amplitude coefficient to a network device based on the target method for reporting the amplitude coefficient.

### CROSS-REFERENCE TO RELATED APPLICATIONS

The present application is a U.S. National Stage of International Application No. PCT/CN2022/128060, filed on Oct. 27, 2022, the contents of all of which are incorporated herein by reference in their entireties for all purposes.

### BACKGROUND OF THE INVENTION

In a case where a network device (such as a base station) has multiple transmission reception points (TRPs), multiple TRPs (multi-TRPs)/multi-panels may be configured to provide services to a terminal.

### SUMMARY OF THE INVENTION

The present disclosure relates to the technical field of communications, and provides a method and device for reporting an amplitude coefficient, and a storage medium.

According to a first aspect of embodiments of the present disclosure, a method for reporting an amplitude coefficient is provided. The method is performed by a terminal and includes: determining a target method for reporting the amplitude coefficient in a case where at least two methods for reporting the amplitude coefficient are supported; and reporting the amplitude coefficient to a network device based on the target method for reporting the amplitude coefficient.

According to a second aspect of embodiments of the present disclosure, a method for reporting an amplitude coefficient is provided. The method is performed by a network device and includes: receiving the amplitude coefficient reported by a terminal based on a target method for reporting the amplitude coefficient.

According to a third aspect of embodiments of the present disclosure, a terminal is provided. The terminal includes: one or more processors; and a memory that stores processor-executable instructions; where the one or more processors are collectively configured to: determine a target method for reporting the amplitude coefficient in a case where at least two methods for reporting the amplitude coefficient are supported; and report the amplitude coefficient to a network device based on the target method for reporting the amplitude coefficient.

According to a fourth aspect of embodiments of the present disclosure, a network device is provided. The device includes: one or more processors; and a memory that stores processor-executable instructions; where the one or more processors are collectively configured to perform the method described in the above second aspect and any of the implementations of the second aspect.

It is to be understood that the above general description and the following detailed description are merely for example and explanatory, and cannot limit the present disclosure.

### BRIEF DESCRIPTION OF DRAWINGS

Accompanying drawings here, which are incorporated in and constitute a part of this specification, illustrate embodiments consistent with the present disclosure and together with the specification, serve to explain the principles of the present disclosure.

FIG. 1 is a schematic diagram of a wireless communication system shown according to an example.

FIG. 2 is a flowchart of a method for reporting an amplitude coefficient shown according to an example.

FIG. 3 is a flowchart of a method for reporting an amplitude coefficient shown according to an example.

FIG. 4 is a flowchart of a method for reporting an amplitude coefficient shown according to an example.

FIG. 5 is a flowchart of a method for reporting an amplitude coefficient shown according to an example.

FIG. 6 is a flowchart of a method for reporting an amplitude coefficient shown according to an example.

FIG. 7 is a flowchart of a method for reporting an amplitude coefficient shown according to an example.

FIG. 8 is a flowchart of a method for reporting an amplitude coefficient shown according to an example.

FIG. 9 is a flowchart of a method for reporting an amplitude coefficient shown according to an example.

FIG. 10 is a block diagram of a device for reporting an amplitude coefficient shown according to an example.

FIG. 11 is a block diagram of a device for reporting an amplitude coefficient shown according to an example.

FIG. 12 is a block diagram of a communication device shown according to an example.

FIG. 13 is a block diagram of a communication device shown according to an example.

### DETAILED DESCRIPTION OF THE INVENTION

Examples will be illustrated in detail here, instances of which are represented in the accompanying drawings. When the following descriptions refer to the accompanying drawings, the same number in the different accompanying drawings represents the same or similar elements unless otherwise indicated. The implementations described in the following examples do not represent all implementations consistent with the present disclosure.

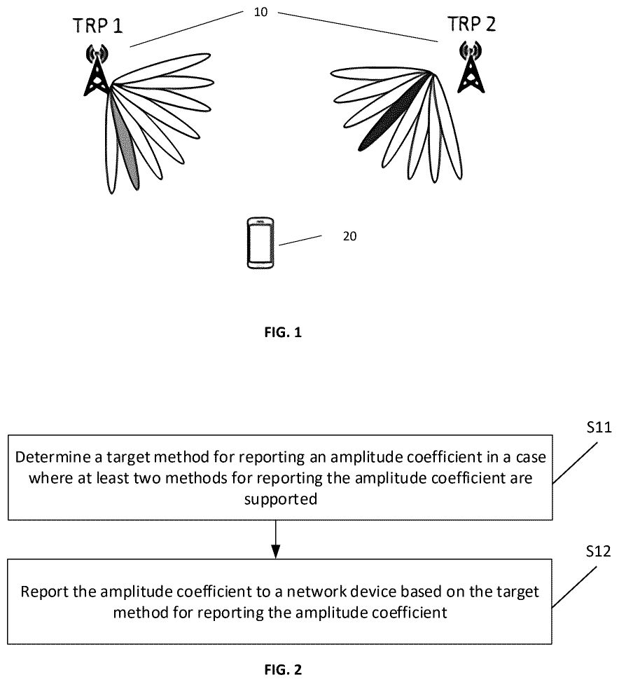

A method for reporting an amplitude coefficient provided by embodiments of the present disclosure may be performed by a wireless communication system shown in FIG. 1. Referring to FIG. 1, the wireless communication system includes a network device 10 and a terminal 20. The terminal 20 is connected with the network device 10 through a wireless resource, and performs data transmission.

It may be understood that the wireless communication system shown in FIG. 1 is merely a schematic illustration, and the wireless communication system may further include other network devices, for example, may further include a core network device, a wireless relay device, a wireless backhaul device, etc., which is not drawn in FIG. 1. The embodiment of the present disclosure does not limit the number of the network devices and the number of the terminals included in the wireless communication system.

It may be further understood that the wireless communication system according to the embodiment of the present disclosure is a network providing a wireless communication function. The wireless communication systems may employ different communication technologies, such as code division multiple access (CDMA), wideband code division multiple access (WCDMA), time division multiple access (TDMA), frequency division multiple access (FDMA), orthogonal frequency-division multiple access (OFDMA), single carrier frequency division multiple access (single Carrier FDMA, SC-FDMA), and carrier sense multiple access with collision avoidance. A network may be divided into a 2G (generation) network, a 3G network, a 4G network or a future evolution network, such as a 5G network according to capacity, speed, delay and other factors of the different networks. The 5G network may also be referred to as a new radio (NR) network. For convenience of description, the present disclosure sometimes refers to the wireless communication network simply as the network.

Further, the network device 10 involved in the present disclosure may also be referred to as a radio access network device. The wireless access network device may be: a base station, an evolved node B (base station), a femto, an access point (AP) in a wireless fidelity (WIFI) system, a wireless relay node, a wireless backhaul node, a transmission point (TP) or a transmission and reception point (TRP), etc., such as TRP 1 and TRP 2 as shown in FIG. 1. The wireless access network device may further be a gNB in an NR system, or may further be a component or part of a device that constitutes a base station. It is to be understood that a specific technology and a specific device form employed by the network device 10 are not limited in the embodiment of the present disclosure. In the present disclosure, the network device 10 may provide communication coverage for a specific geographic region, and may communicate with a terminal 20 located within a coverage region (a cell). In addition, in a case where it is a vehicle-to-everything (V2X) communication system, the network device 10 may also be an on-board device.

Further, the terminal 20 involved in the present disclosure may also be referred to as a terminal device, user equipment (UE), a mobile station (MS), a mobile terminal (MT), etc., and is a device that provides voice and/or data connectivity to a user. For example, the terminal 20 may be a handheld device and an on-board device with a wireless connection function. At present, some examples of the terminal 20 are: a mobile phone, customer premise equipment (CPE), a pocket personal computer (PPC), a palm computer, a personal digital assistant (PDA), a notebook computer, a tablet computer, a wearable device, or the on-board device, etc. In addition, in a case where it is a vehicle-to-everything (V2X) communication system, the terminal device may further be the on-board device. It is to be understood that the specific technology and the specific device form employed by the terminal 20 are not limited in the embodiment of the present disclosure.

In a case where the network device 10 (such as a base station) has multiple transmission reception points (TRPs), multiple TRPs (multi-TRPs)/multi-panels may be configured to provide services to the terminal 20.

In the related art, there are various methods for reporting the amplitude coefficient of a TRP to the network device by the terminal. In a case where the terminal has a capability to support multiple reporting solutions, how to determine an actual method for reporting the amplitude coefficient by the terminal is a problem that needs to be solved.

Based on this, an embodiment of the present disclosure provides a method for reporting an amplitude coefficient. A target method for reporting the amplitude coefficient is determined in a case where a terminal supports at least two methods for reporting the amplitude coefficient, and the amplitude coefficient is reported to a network device based on the target method for reporting the amplitude coefficient. Thus, the terminal may determine a target method for reporting the amplitude coefficient actually used by the terminal when reporting the amplitude coefficient, so as to avoid failed or delayed reporting of the amplitude coefficient due to a fact that the terminal does not know which method for reporting the amplitude coefficient is adopted. At the same time, the terminal and the network device reach an agreement on which method for reporting the amplitude coefficient is adopted, and signaling overheads of channel state information (CSI) reporting are reduced while improving transmission performance based on multi-TRPs.

FIG. 2 is a flowchart of a method for reporting an amplitude coefficient shown according to an example. As shown in FIG. 2, the method for reporting the amplitude coefficient is performed by a terminal, and includes the following steps, S11-S12.

In step S11, a target method for reporting the amplitude coefficient is determined in a case where at least two methods for reporting the amplitude coefficient are supported.

In step S12, the amplitude coefficient is reported to a network device based on the target method for reporting the amplitude coefficient.

The target method for reporting the amplitude coefficient may be understood as a method for reporting the amplitude coefficient actually adopted by the terminal. The target method for reporting the amplitude coefficient in all the following embodiments is applicable.

In the embodiment of the present disclosure, the target method for reporting the amplitude coefficient is determined in the case where the terminal supports at least two methods for reporting the amplitude coefficient, and the amplitude coefficient is reported to the network device based on the target method for reporting the amplitude coefficient. Thus, the terminal may determine the target method for reporting the amplitude coefficient actually used by the terminal when reporting the amplitude coefficient, so as to avoid failed or delayed reporting of the amplitude coefficient due to a fact that the terminal does not know which method for reporting the amplitude coefficient is adopted. At the same time, the terminal and the network device reach an agreement on which method for reporting the amplitude coefficient is adopted, and signaling overheads of CSI reporting are reduced while improving transmission performance based on multi-TRPs.

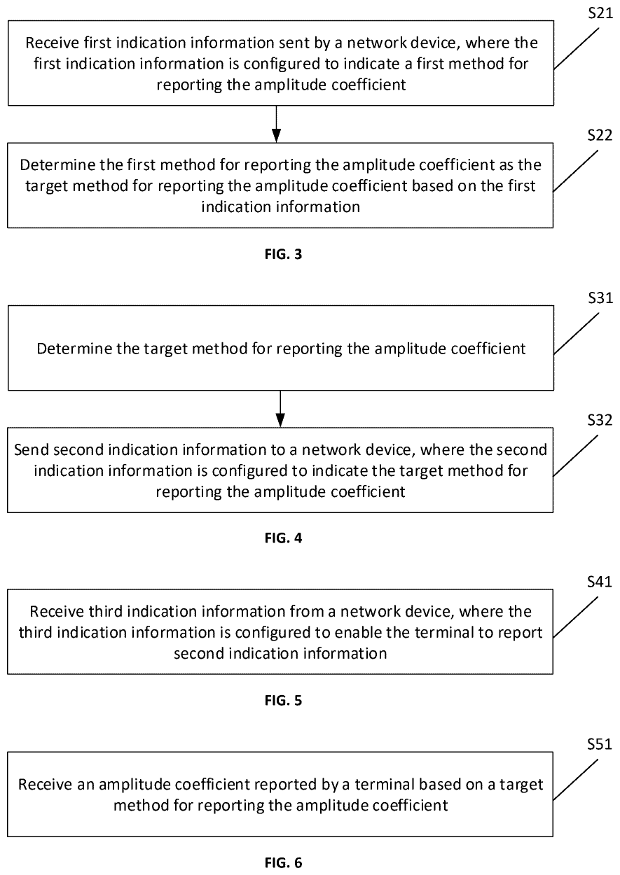

In the embodiment of the present disclosure, there are many methods for the terminal to determine the target method for reporting the amplitude coefficient, for example, the target method for reporting the amplitude coefficient is determined through indication information sent by the network device, or determined by the terminal itself. In the embodiment of the present disclosure, these manners are illustrated respectively through a plurality of methods shown in FIG. 3 to FIG. 5. It is to be noted that a plurality of solutions shown in FIG. 3 to FIG. 5 in the embodiment of the present disclosure may be implemented independently, or any one of the embodiments may be implemented together with other embodiments.

In the method for reporting the amplitude coefficient provided by the embodiment of the present disclosure, the target method for reporting the amplitude coefficient is determined based on first indication information sent by the network device. As shown in FIG. 3, FIG. 3 is a flowchart of a method for reporting an amplitude coefficient shown according to an example. The method includes the following steps, S21-S22.

In step S21, first indication information sent by a network device, where the first indication information is configured to indicate a first method for reporting the amplitude coefficient.

In step S22, the first method for reporting the amplitude coefficient is determined as a target method for reporting the amplitude coefficient based on the first indication information.

In an example, the first indication information may be carried through radio resource control (RRC) signaling, medium access control control element (MAC CE) signaling, and/or downlink control information (DCI).

In the embodiment of the present disclosure, the network device sends the first indication information to the terminal, where the first indication information is configured to indicate the first method for reporting the amplitude coefficient, thus the terminal may determine the first method for reporting the amplitude coefficient as the target method for reporting the amplitude coefficient based on the first indication information. Accordingly, the network device and the terminal may maintain consistency in the method for reporting the amplitude coefficient actually used by the terminal, and signaling overheads of CSI reporting are reduced while improving transmission performance based on multi-TRPs.

In the method for reporting the amplitude coefficient provided by the embodiment of the present disclosure, the first indication information is further configured to indicate at least one channel measurement resource (CMR) corresponding to the first method for reporting the amplitude coefficient.

The at least one CMR includes at least one non-zero power channel state information-reference signal (NZP CSI-RS) resource, where each NZP CSI-RS resource corresponds to a different TRP.

In some embodiments, the first method for reporting the amplitude coefficient corresponding to each CMR in the at least one CMR may be the same or different.

In an example, in a case where the first indication information does not indicate a CMR corresponding to the first method for reporting the amplitude coefficient, the first method for reporting the amplitude coefficient corresponding to each CMR in at least one CMR is the same. That is, the first method for reporting the amplitude coefficient indicated by the first indication information is applicable to the plurality of CMRs of the terminal.

In another example, in a case where the first indication information indicates one or more CMRs corresponding to the first method for reporting the amplitude coefficient, a different CMR in at least one CMR may be configured with a different first method for reporting the amplitude coefficient. That is, the first indication information may independently configure the first method for reporting the amplitude coefficient for the different CMR, and the first method for reporting the amplitude coefficient corresponding to the different CMR may be the same or different.

For example, the network device may determine the first method for reporting the amplitude coefficient corresponding to the CMR based on a location of a TRP corresponding to an NZP CSI-RS resource included in the CMR.

More specifically, in a case where locations of TRPs corresponding to NZP CSI-RS resources included in CMRs are close, then the first method for reporting the amplitude coefficient is a method 1 for reporting the amplitude coefficient. In a case where the locations of the TRPs corresponding to the NZP CSI-RS resources included in the CMRs are far away, then the first method for reporting the amplitude coefficient may be a method 2 for reporting the amplitude coefficient different from the method 1 for reporting the amplitude coefficient.

For another example, the network device may determine the first method for reporting the amplitude coefficient corresponding to the CMR based on transmitting power of the TRP corresponding to the NZP CSI-RS resource included in the CMR.

More specifically, in a case where the transmitting power of the TRPs corresponding to the NZP CSI-RS resources included in the CMRs is close or the same, then the first method for reporting the amplitude coefficient is a method 1 for reporting the amplitude coefficient. In a case where the transmitting power of the TRPs corresponding to the NZP CSI-RS resources included in the CMRs has a big difference, then the first method for reporting the amplitude coefficient may be a method 2 for reporting the amplitude coefficient different from the method 1 for reporting the amplitude coefficient.

In the embodiment of the present disclosure, the first method for reporting the amplitude coefficient corresponding to each CMR in the at least one CMR may be the same or different, and thus the transmission performance based on the multi-TRPs is improved.

In the method for reporting the amplitude coefficient provided by the embodiment of the present disclosure, the terminal determines the target method for reporting the amplitude coefficient by itself and informs the network device of the target method for reporting the amplitude coefficient. As shown in FIG. 4, FIG. 4 is a flowchart of a method for reporting an amplitude coefficient shown according to an example. The method includes the following steps, S31-S32.

In step S31, a target method for reporting the amplitude coefficient is determined.

In some embodiments, the terminal may determine the target method based on at least one of reference signal received power (RSRP), reference signal received quality (RSRQ), or signal to interference and noise ratio (SINR) corresponding to a different NZP CSI-RS.

In an example, in a case where a difference in the RSRP between the different NZP CSI-RS is small, the target method for reporting the amplitude coefficient is determined as a method 1, otherwise the target method for reporting the amplitude coefficient is determined as a method 2. The RSRP may include at least one of Layer1(L1)-RSRP or L3-RSRP.

In another example, in a case where a difference in the RSRQ between the different NZP CSI-RS is small, the target method for reporting the amplitude coefficient is determined as a method 1, otherwise the target method for reporting the amplitude coefficient is determined as a method 2. The RSRQ may include at least one of L1-RSRQ or L3-RSRQ.

In another example, in a case where a difference in the SINR between the different NZP CSI-RS is small, the target method for reporting the amplitude coefficient is determined as a method 1, otherwise the target method for reporting the amplitude coefficient is determined as a method 2. The SINR may include at least one of L1-SINR or L3-SINR.

In step S32, second indication information is sent to a network device, where the second indication information is configured to indicate the target method for reporting the amplitude coefficient.

In the embodiment of the present disclosure, the terminal determines the target method for reporting the amplitude coefficient by itself and sends the second indication information to the network device, where the second indication information is configured to indicate the target method for reporting the amplitude coefficient. Thus, the network device may determine the method for reporting the amplitude coefficient actually used by the terminal based on the second indication information, so that the network device and the terminal may maintain consistency in the method for reporting the amplitude coefficient actually used by the terminal, and signaling overheads of CSI reporting are reduced while improving transmission performance based on multi-TRPs.

In the method for reporting the amplitude coefficient provided by the embodiment of the present disclosure, the terminal first needs to determine whether it can report the second indication information before sending the second indication information. As shown in FIG. 5, FIG. 5 is a flowchart of a method for reporting an amplitude coefficient shown according to an example. The method includes the following step, S41.

In step S41, third indication information is received from a network device, where the third indication information is configured to enable a terminal to report second indication information.

In some embodiments, the second indication information is used by the terminal to inform the network device of the method for reporting the amplitude coefficient actually used by itself.

In the embodiment of the present disclosure, the terminal receives the third indication information from the network device. Because the third indication information is configured to enable the terminal to report the second indication information, in a case where the second indication information is configured to indicate the target method for reporting the amplitude coefficient, the network device may determine the method for reporting the amplitude coefficient actually used by the terminal as a target transmission method based on the second indication information, so that the network device and the terminal may maintain consistency in the method for reporting the amplitude coefficient actually used by the terminal, and signaling overheads of CSI reporting are reduced while improving transmission performance based on multi-TRPs.

In some embodiments of the method for reporting the amplitude coefficient provided by the embodiment of the present disclosure, the second indication information is carried in CSI.

In the embodiment of the present disclosure, the second indication information is carried in the CSI, and the second indication information can be reported while reporting the CSI, so as to reduce signaling consumption.

In the method for reporting the amplitude coefficient provided by the embodiment of the present disclosure, the CSI includes first information and second information.

The first information corresponds to an indication field with a fixed size, a size of an indication field corresponding to the second information is determined based on the first information; and the second indication information is carried in the first information.

In an example, the CSI may include two parts, namely a part 1 and a part 2. The part 1 may correspond to the first information, and the part 2 may correspond to the second information.

In another example, the size of the indication field corresponding to the first information may be a fixed value. For example, the size may be pre-set or a default size specified in a protocol.

In another example, the size of the part 2 of the CSI is determined based on information in the part 1. The size of the part 2 represents a number of bits occupied by the part 2 of the CSI. For example, 8 bits or 16 bits are occupied.

For example, the size of the part 2 of the CSI is determined based on the second indication information in the part 1. In a case where the second indication information in the part 1 indicates that the method for reporting the amplitude coefficient actually used by the terminal is a first method for reporting the amplitude coefficient, then the size of the part 2 is smaller. Otherwise, in a case where the second indication information in the part 1 indicates that the method for reporting the amplitude coefficient actually used by the terminal is a second method for reporting the amplitude coefficient, then the size of the part 2 is larger.

In another example, the second indication information is carried in the first information. The method for reporting the amplitude coefficient actually used by the terminal is indicated by the indication field of the method for reporting the amplitude coefficient in the first information.

For example, in a case where a bit indicated by the indication field of the method for reporting the amplitude coefficient in the first information is 0, the second indication information indicates that the method for reporting the amplitude coefficient actually used by the terminal is the first method for reporting the amplitude coefficient. In a case where the bit indicated by the indication field of the method for reporting the amplitude coefficient in the first information is 1, the second indication information indicates that the method for reporting the amplitude coefficient actually used by the terminal is the second method for reporting the amplitude coefficient.

In the embodiment of the present disclosure, by dynamically adjusting the size of different parts of the CSI, in a case where the second indication information indicates that the method for reporting the amplitude coefficient actually used by the terminal is the first method for reporting the amplitude coefficient, since the first method for reporting the amplitude coefficient divides at least one NZP CSI-RS into two groups, the signaling overhead of CSI reporting may be reduced when the terminal communicates with multi-TRPs.

In the method for reporting the amplitude coefficient provided by the embodiment of the present disclosure, the first information further includes at least one of: a channel state information reference signal resource indicator (CRI); rank indication information; NZP CSI-RS selection information; a broadband channel quality indicator (CQI); a number of non-zero broadband amplitude coefficients; indication information of a number of non-zero coefficients; indication information of a location of a non-zero coefficient; or mode indication information.

In an example, the first information includes the number of the non-zero broadband amplitude coefficients.

It may be understood that the number of the non-zero broadband amplitude coefficients represents the number of non-zero broadband amplitude coefficient values.

In an example, the first information includes the indication information of the number of the non-zero coefficients.

It may be understood that the indication information of the number of the non-zero coefficients may indicate the number of coefficients with non-zero coherent coefficients.

In an example, the first information includes the indication information of the location of the non-zero coefficient.

It may be understood that the indication information of the location of the non-zero coefficient may indicate the location of the coefficient with the non-zero coherent coefficient.

In an example, the first information includes mode indication.

For example, mode indication may be configured to indicate a CSI feedback mode, a codebook mode, etc. The CSI feedback mode may include a mode 1 and a mode 2, where the mode 1 is feedback based on a single TRP and a mode 2 is feedback based on multi-TRPs. Certainly, the CSI feedback mode may also include other modes, which is not limited in the present disclosure. The codebook mode may include a codebook structure 1 and a codebook structure 2. The codebook structure 1 provides feedback on frequency domain basis (FD basis) vector information for all the NZP CSI-RSs, and the codebook structure 2 provides feedback on frequency domain basis vector information for each NZP CSI-RS respectively. The codebook mode may also include other modes, which is not limited in the present disclosure.

In the method for reporting the amplitude coefficient provided by the embodiment of the present disclosure, the second information includes precoding matrix indicator (PMI) information.

The PMI information at least includes at least one of: parameter information of a spatial domain basis vector; parameter information of a frequency domain basis vector; the indication information of the location of the non-zero coefficient; phase coefficient information; or amplitude coefficient information.

In the method for reporting the amplitude coefficient provided by the embodiment of the present disclosure, the terminal merely needs to determine the target method for reporting the amplitude coefficient in a case where a method of receiving a physical downlink shared channel by the terminal is the target transmission method. Hence, the terminal needs to determine a transmission method of the physical downlink shared channel as the target transmission method.

In the embodiment of the present disclosure, the target transmission method may be referred to as a coherent joint transmission (CJT) method. Except for the embodiment of the present disclosure, the target transmission methods appearing in all the embodiments below may be referred to as the CJT method.

In the embodiment of the present disclosure, through determining the method for receiving the physical downlink shared channel by the terminal as the target transmission method, it is determined that the terminal needs to select the method for reporting the amplitude coefficient to report the amplitude coefficient.

In the method for reporting the amplitude coefficient provided by the embodiment of the present disclosure, the target transmission method meets at least one of: A. each CMR in the at least one CMR includes at least one NZP CSI-RS resource; B. the terminal reports the parameter information of the spatial domain basis vector respectively for each NZP CSI-RS resource; C. the terminal reports the parameter information of the frequency domain basis vector respectively for each NZP CSI-RS resource; D. the terminal reports the parameter information of the frequency domain basis vector respectively for each CMR; E. each NZP CSI-RS resource corresponds to a TRP; or F. a number of TCI states corresponding to PDSCH transmission is at least one.

The target transmission method may meet any one feature, or any two features, or any three features of A to F, etc. The embodiment of the present disclosure does not limit a combination of A to F.

In an example, the target transmission method meets that the terminal reports the parameter information of the spatial domain basis vector respectively for each NZP CSI-RS resource.

For example, the spatial domain basis vector is reported by selecting a specified number (L) of beams from the total number N1*N2 of antenna ports of each NZP CSI-RS resource. Where, N1 is a number of antenna ports in a first dimension, and N2 is a number of antenna ports in a second dimension. The L value may be the same or different for different NZP CSI-RS resource.

The terminal reports the parameter information of the frequency domain basis vector respectively for each NZP CSI-RS resource.

For example, M frequency domain basis vectors are respectively selected from N3 frequency domain basis vectors for each NZP CSI-RS resource. N3 represents a product of a number of channel quality indication subbands (CQI-subbands) and a number of precoding matrix index subbands (PMI-subbands) included in each CQI-subband. The M value may be the same or different for different NZP CSI-RS resource.

In an example, the target transmission method meets that the terminal reports the parameter information of the frequency domain basis vector respectively for each CMR.

For example, for a CMR, even if the CMR includes a plurality of NZP CSI-RS resources, the terminal merely needs to select M identical frequency domain basis vectors from N3 frequency domain basis vectors for all the NZP CSI-RS resources in the CMR. The terminal does not need to select the M frequency domain basis vectors respectively for each NZP CSI-RS resource.

In the embodiment of the present disclosure, by judging whether a current transmission method meets a feature of the target transmission method, whether the current transmission method belongs to the target transmission method may be determined, and whether the terminal needs to determine the actually used method for reporting the amplitude coefficient is further determined.

In the method for reporting the amplitude coefficient provided by the embodiment of the present disclosure, the target method for reporting the amplitude coefficient is a method for reporting the amplitude coefficient that must be supported by the terminal in a case where the terminal supports the target transmission method; and/or the target method for reporting the amplitude coefficient is a method for reporting the amplitude coefficient that is optionally supported by the terminal.

In an example, the method for reporting the amplitude coefficient that must be supported by the terminal in a case where the terminal supports the target transmission method is the method 1 for reporting the amplitude coefficient, and the method for reporting the amplitude coefficient that is optionally supported by the terminal is the method 2 for reporting the amplitude coefficient. The terminal needs to report capability information to the network device, and inform the network device through the capability information that it supports the method 2 for reporting the amplitude coefficient. Then, the target method for reporting the amplitude coefficient actually used by the terminal may be the method 1 for reporting the amplitude coefficient or the method 2 for reporting the amplitude coefficient.

In another example, the method for reporting the amplitude coefficient that must be supported by the terminal in a case where the terminal supports the target transmission method is the method 2 for reporting the amplitude coefficient, and the method for reporting the amplitude coefficient that is optionally supported by the terminal is the method 1 for reporting the amplitude coefficient. The terminal needs to report capability information to the network device, and inform the network device through the capability information that it supports the method 1 for reporting the amplitude coefficient. Then, the target method for reporting the amplitude coefficient actually used by the terminal may be the method 1 for reporting the amplitude coefficient or the method 2 for reporting the amplitude coefficient.

In the method for reporting the amplitude coefficient provided by the embodiment of the present disclosure, the target method for reporting the amplitude coefficient includes at least one of: A. two groups of amplitude coefficients are reported, where a first group of amplitude coefficients includes amplitude coefficients in a first polarization direction, where a second group of amplitude coefficients includes amplitude coefficients in a second polarization direction, and where the first polarization direction corresponds to a polarization direction where a strongest amplitude coefficient is located; or B. 2N groups of amplitude coefficients are reported, where N is a number of NZP CSI-RSs included in a CMR, where each NZP CSI-RS corresponds to two groups of amplitude coefficients corresponding to different polarization directions, and where N is a positive integer.

In an example, in a case where the target method for reporting the amplitude coefficient includes a method A, in this case, the strongest amplitude coefficient in the polarization direction where the strongest coefficient indicator (SCI) is located defaults to be 1, the terminal does not need to report the amplitude coefficient, and the terminal merely needs to report amplitude coefficients at other locations in the polarization direction, where the amplitude coefficients at other locations are differential values from 1. The terminal independently reports a reference amplitude in another polarization direction and reports amplitude coefficients at other locations in the other polarization direction, where the amplitude coefficients at other locations are differential values from the reference amplitude in the another polarization direction.

In another example, in a case where the target method for reporting the amplitude coefficient includes a method B, in this case, the strongest amplitude coefficient within a group where the SCI is located defaults to be 1, the terminal does not need to report the amplitude coefficient, and the terminal merely needs to report amplitude coefficients at other locations within this group, where the amplitude coefficients at other locations are differential values from 1. For other 2N−1 groups, the terminal reports one reference amplitude for each group and reports the amplitude coefficients at other locations within this group, where the amplitude coefficients at other locations are differential values from the reference amplitude in a polarization direction. Compared with the method A, the method B needs to additionally report 2N−2 reference amplitudes, so in a case where N is greater than 1, signaling overheads of the method B are relatively higher, that is, the size of the CSI second information corresponding to the method B is larger.

In the embodiment of the present disclosure, in a case where the target method for reporting the amplitude coefficient is the method A, since the terminal merely needs to report two groups of amplitude coefficients, CSI signaling consumption can be reduced when the terminal reports a target amplitude coefficient through the CSI.

Based on the same concept, the present disclosure further provides a method for reporting an amplitude coefficient performed by a network device.

FIG. 6 is a flowchart of a method for reporting an amplitude coefficient shown according to an example. As shown in FIG. 6, the method for reporting the amplitude coefficient is performed by the network device, and includes the following step, S51.

In step S51, an amplitude coefficient reported by a terminal based on a target method for reporting the amplitude coefficient is received.

The target method for reporting the amplitude coefficient may be understood as a method for reporting the amplitude coefficient actually adopted by the terminal. Target amplitude coefficients in all the following embodiments are applicable.

In the embodiment of the present disclosure, the terminal may report the amplitude coefficient based on the target method for reporting the amplitude coefficient, so as to avoid failed or delayed reporting of the amplitude coefficient due to a fact that the terminal does not know which method for reporting the amplitude coefficient is adopted. At the same time, the terminal and the network device reach an agreement on which method for reporting the amplitude coefficient is adopted, and signaling overheads of CSI reporting are reduced while improving transmission performance based on multi-TRPs.

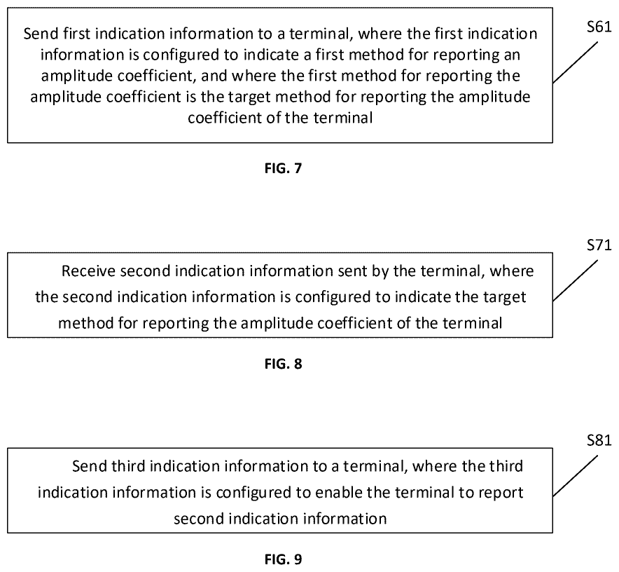

In the embodiment of the present disclosure, there are many methods for the terminal to determine the target method for reporting the amplitude coefficient, for example, the target method for reporting the amplitude coefficient is determined through indication information sent by the network device, or determined by the terminal itself. In the embodiment of the present disclosure, these manners are illustrated respectively through a plurality of methods shown in FIG. 7 to FIG. 9. It is to be noted that a plurality of solutions shown in FIG. 7 to FIG. 9 in the embodiment of the present disclosure may be implemented independently, or any one of the embodiments may be implemented together with other embodiments.

In the method for reporting the amplitude coefficient provided by the embodiment of the present disclosure, the target method for reporting the amplitude coefficient is determined based on first indication information sent by the network device. As shown in FIG. 7, FIG. 7 is a flowchart of a method for reporting an amplitude coefficient shown according to an example. The method includes the following step, S61.

In step S61, first indication information is sent to a terminal, where the first indication information is configured to indicate a first method for reporting the amplitude coefficient, and the first method for reporting the amplitude coefficient is a target method for reporting the amplitude coefficient of the terminal.

In an example, the first indication information may be carried through RRC signaling, MAC CE signaling, and/or DCI.

In the embodiment of the present disclosure, the network device sends the first indication information to the terminal, where the first indication information is configured to indicate the first method for reporting the amplitude coefficient, thus the terminal may determine the first method for reporting the amplitude coefficient as the target method for reporting the amplitude coefficient based on the first indication information. Accordingly, the network device and the terminal may maintain consistency in the method for reporting the amplitude coefficient actually used by the terminal, and signaling overheads of CSI reporting are reduced while improving transmission performance based on multi-TRPs.

In the method for reporting the amplitude coefficient provided by the embodiment of the present disclosure, the first indication information is further configured to indicate at least one channel measurement resource (CMR) corresponding to the first method for reporting the amplitude coefficient.

The at least one CMR includes at least one non-zero power (NZP) channel state information-reference signal (CSI-RS) resource, and each NZP CSI-RS resource corresponds to a different TRP.

In some embodiments, the first method for reporting the amplitude coefficient corresponding to each CMR in the at least one CMR may be the same or different.

In an example, in a case where the first indication information does not indicate the CMRs corresponding to the first method for reporting the amplitude coefficient, the first method for reporting the amplitude coefficient corresponding to each CMR in at least one CMR is the same. That is, the first method for reporting the amplitude coefficient indicated by the first indication information is applicable to the plurality of CMRs of the terminal.

In another example, in a case where the first indication information indicates the one or more CMRs corresponding to the first method for reporting the amplitude coefficient, the different CMR in at least one CMR may be configured with the different first method for reporting the amplitude coefficient. That is, the first indication information may independently configure the first method for reporting the amplitude coefficient for the different CMR, and the first method for reporting the amplitude coefficient corresponding to the different CMRs may be the same or different.

For example, the network device may determine the first method for reporting the amplitude coefficient corresponding to the CMR based on the location of the TRP corresponding to the NZP CSI-RS resource included in the CMR.

More specifically, in a case where the locations of the TRPs corresponding to the NZP CSI-RS resources included in the CMRs are close, then the first method for reporting the amplitude coefficient is a method 1 for reporting the amplitude coefficient. In a case where the locations of the TRPs corresponding to the NZP CSI-RS resources included in the CMRs are far away, then the first method for reporting the amplitude coefficient may be a method 2 for reporting the amplitude coefficient different from the method 1 for reporting the amplitude coefficient.

For another example, the network device may determine the first method for reporting the amplitude coefficient corresponding to the CMR based on transmitting power of the TRP corresponding to the NZP CSI-RS resource included in the CMR.

More specifically, in a case where the transmitting power of the TRPs corresponding to the NZP CSI-RS resources included in the CMRs is close or the same, then the first method for reporting the amplitude coefficient is a method 1 for reporting the amplitude coefficient. In a case where the transmitting power of the TRPs corresponding to the NZP CSI-RS resources included in the CMRs has a big difference, then the first method for reporting the amplitude coefficient may be a method 2 for reporting the amplitude coefficient different from the method 1 for reporting the amplitude coefficient.

In the embodiment of the present disclosure, the first method for reporting the amplitude coefficient corresponding to each CMR in the at least one CMR may be the same or different, and thus the transmission performance based on the multi-TRPs is improved.

In the method for reporting the amplitude coefficient provided by the embodiment of the present disclosure, the terminal determines the target method for reporting the amplitude coefficient by itself and informs the network device of the target method for reporting the amplitude coefficient. As shown in FIG. 8, FIG. 8 is a flowchart of a method for reporting an amplitude coefficient shown according to an example. The method includes the following step, S71.

In step S71, second indication information sent by the terminal is received, where the second indication information is configured to indicate the target method for reporting the amplitude coefficient of the terminal.

In the embodiment of the present disclosure, the terminal determines the target method for reporting the amplitude coefficient by itself and sends the second indication information to the network device, where the second indication information is configured to indicate the target method for reporting the amplitude coefficient. Thus, the network device may determine the method for reporting the amplitude coefficient actually used by the terminal based on the second indication information, so that the network device and the terminal may maintain consistency in the method for reporting the amplitude coefficient actually used by the terminal, and signaling overheads of CSI reporting are reduced while improving transmission performance based on multi-TRPs.

In the embodiment of the present disclosure, the terminal may determine the target method based on at least one of RSRP, RSRQ, or SINR corresponding to the different NZP CSI-RS.

In an example, in a case where a difference in the RSRP between the different NZP CSI-RS is small, the target method for reporting the amplitude coefficient is determined as a method 1, otherwise the target method for reporting the amplitude coefficient is determined as a method 2. The RSRP may include at least one of Layer1(L1)-RSRP or L3-RSRP.

In another example, in a case where a difference in the RSRQ between the different NZP CSI-RS is small, the target method for reporting the amplitude coefficient is determined as a method 1, otherwise the target method for reporting the amplitude coefficient is determined as a method 2. The RSRQ may include at least one of L1-RSRQ or L3-RSRQ.

In another example, in a case where a difference in the SINR between the different NZP CSI-RS is small, the target method for reporting the amplitude coefficient is determined as a method 1, otherwise the target method for reporting the amplitude coefficient is determined as a method 2. The SINR may include at least one of L1-SINR or L3-SINR.

In the method for reporting the amplitude coefficient provided by the embodiment of the present disclosure, the network device needs to enable the terminal to report the second indication information before receiving the second indication information. As shown in FIG. 9, FIG. 9 is a flowchart of a method for reporting an amplitude coefficient shown according to an example. The method includes the following step, S81.

In step S81, third indication information is sent to a terminal, where the third indication information is configured to enable the terminal to report second indication information.

In some embodiments, the second indication information is used by the terminal to inform a network device of the method for reporting the amplitude coefficient actually used by itself.

In the embodiment of the present disclosure, the network device sends the third indication information to the terminal. Because the third indication information is configured to enable the terminal to report the second indication information, in a case where the second indication information is configured to indicate the target method for reporting the amplitude coefficient, the network device may determine the method for reporting the amplitude coefficient actually used by the terminal as a target transmission method based on the second indication information sent by the terminal, so that the network device and the terminal may maintain consistency in the method for reporting the amplitude coefficient actually used by the terminal, and signaling overheads of CSI reporting are reduced while improving transmission performance based on multi-TRPs.

In some embodiments of the method for reporting the amplitude coefficient provided by the embodiment of the present disclosure, the second indication information is carried in CSI.

In the embodiment of the present disclosure, the second indication information is carried in the CSI, and the second indication information can be reported while reporting the CSI, so as to reduce signaling consumption.

In the method for reporting the amplitude coefficient provided by the embodiment of the present disclosure, the CSI includes first information and second information.

The first information corresponds to an indication field with a fixed size, a size of an indication field corresponding to the second information is determined based on the first information; and the second indication information is carried in the first information.

In an example, the CSI may include two parts, namely a part 1 and a part 2. The part 1 may correspond to the first information, and the part 2 may correspond to the second information.

In another example, the size of the indication field corresponding to the first information may be a fixed value. For example, the size may be pre-set or a default size specified in a protocol.

In another example, the size of the part 2 of the CSI is determined based on information in the part 1. The size of the part 2 represents the number of bits occupied by the part 2 of the CSI. For example, 8 bits or 16 bits are occupied.

For example, the size of the part 2 of the CSI is determined based on the second indication information in the part 1. In a case where the second indication information in the part 1 indicates that the method for reporting the amplitude coefficient actually used by the terminal is a first method for reporting the amplitude coefficient, then the size of the part 2 is smaller. Otherwise, in a case where the second indication information in the part 1 indicates that the method for reporting the amplitude coefficient actually used by the terminal is a second method for reporting the amplitude coefficient, then the size of the part 2 is larger.

In another example, the second indication information is carried in the first information. The method for reporting the amplitude coefficient actually used by the terminal is indicated by the indication field of the method for reporting the amplitude coefficient in the first information.

For example, in a case where a bit indicated by the indication field of the method for reporting the amplitude coefficient in the first information is 0, the second indication information indicates that the method for reporting the amplitude coefficient actually used by the terminal is the first method for reporting the amplitude coefficient. In a case where the bit indicated by the indication field of the method for reporting the amplitude coefficient in the first information is 1, the second indication information indicates that the method for reporting the amplitude coefficient actually used by the terminal is the second method for reporting the amplitude coefficient.

In the embodiment of the present disclosure, by dynamically adjusting the size of different parts of the CSI, in a case where the second indication information indicates that the method for reporting the amplitude coefficient actually used by the terminal is the first method for reporting the amplitude coefficient, since the first method for reporting the amplitude coefficient divides at least one NZP CSI-RS into two groups, the signaling overhead of CSI reporting may be reduced when the terminal communicates with multi-TRPs.

In the method for reporting the amplitude coefficient provided by the embodiment of the present disclosure, the first information further includes at least one of: a channel state information reference signal resource indicator (CRI); rank indication information; NZP CSI-RS selection information; a broadband channel quality indicator (CQI); the number of non-zero broadband amplitude coefficients; indication information of the number of non-zero coefficients; indication information of the location of the non-zero coefficient; or mode indication information.

In an example, the first information includes the number of the non-zero broadband amplitude coefficients.

It may be understood that the number of the non-zero broadband amplitude coefficients represents the number of non-zero broadband amplitude coefficient values.

In an example, the first information includes the indication information of the number of the non-zero coefficients.

It may be understood that the indication information of the number of the non-zero coefficients may indicate the number of coefficients with non-zero coherent coefficients.

In an example, the first information includes the indication information of the location of the non-zero coefficient.

It may be understood that the indication information of the location of the non-zero coefficient may indicate the location of the coefficient with the non-zero coherent coefficient.

In an example, the first information includes mode indication.

For example, mode indication may be configured to indicate a CSI feedback mode, a codebook mode, etc. The CSI feedback mode may include a mode 1 and a mode 2, where the mode 1 is feedback based on a single TRP and a mode 2 is feedback based on multi-TRPs. Certainly, the CSI feedback mode may also include other modes, which is not limited in the present disclosure. The codebook mode may include a codebook structure 1 and a codebook structure 2. The codebook structure 1 provides feedback on frequency domain basis (FD basis) vector information for all the NZP CSI-RSs, and the codebook structure 2 provides feedback on frequency domain basis vector information for each NZP CSI-RS respectively. The codebook mode may also include other modes, which is not limited in the present disclosure.

In the method for reporting the amplitude coefficient provided by the embodiment of the present disclosure, the second information includes precoding matrix indicator (PMI) information.

The PMI information at least includes at least one of: parameter information of a spatial domain basis vector; parameter information of a frequency domain basis vector; the indication information of the location of non-zero coefficient; phase coefficient information; or amplitude coefficient information.

In the method for reporting the amplitude coefficient provided by the embodiment of the present disclosure, the terminal merely needs to determine the target method for reporting the amplitude coefficient in a case where a method of receiving a physical downlink shared channel by the terminal is the target transmission method. Hence, the network device needs to determine a method of receiving the physical downlink shared channel by the terminal as the target transmission method.

In the embodiment of the present disclosure, the target transmission method may be referred to as a coherent joint transmission (CJT) method. Except for the embodiment of the present disclosure, the target transmission methods appearing in all the embodiments below may be referred to as the CJT method.

In the method for reporting the amplitude coefficient provided by the embodiment of the present disclosure, the target transmission method meets at least one of: A. each CMR in the at least one CMR includes at least one NZP CSI-RS resource; B. the terminal reports parameter information of the spatial domain basis vector respectively for each NZP CSI-RS resource; C. the terminal reports parameter information of the frequency domain basis vector respectively for each NZP CSI-RS resource; D. the terminal reports the parameter information of the frequency domain basis vector respectively for each CMR; E. each NZP CSI-RS resource corresponds to the TRP; or F. the number of TCI states corresponding to PDSCH transmission is at least one.

The target transmission method may meet any one feature, or any two features, or any three features of A to F, etc. The embodiment of the present disclosure does not limit a combination of A to F.

In an example, the target transmission method meets that the terminal reports the parameter information of the spatial domain basis vector respectively for each NZP CSI-RS resource.

For example, the spatial domain basis vector is reported by selecting a specified number (L) of beams from the total number N1*N2 of antenna ports of each NZP CSI-RS resource. Where, N1 is the number of antenna ports in a first dimension, and N2 is the number of antenna ports in a second dimension. The L value may be the same or different for different NZP CSI-RS resources.

The terminal reports the parameter information of the frequency domain basis vector respectively for each NZP CSI-RS resource.

For example, M frequency domain basis vectors are respectively selected from N3 frequency domain basis vectors for each NZP CSI-RS resource. N3 represents a product of the number of channel quality indication subbands (CQI-subbands) and the number of precoding matrix index subbands (PMI-subbands) included in each CQI-subband. The M value may be the same or different for different NZP CSI-RS resources.

In an example, the target transmission method meets that the terminal reports the parameter information of the frequency domain basis vector respectively for each CMR.

For example, for the CMR, even if the CMR includes the plurality of NZP CSI-RS resources, the terminal merely needs to select M identical frequency domain basis vectors from N3 frequency domain basis vectors for all the NZP CSI-RS resources in the CMR. The terminal does not need to select the M frequency domain basis vectors respectively for each NZP CSI-RS resource.

In the embodiment of the present disclosure, by judging whether a current transmission method meets the feature of the target transmission method, whether the current transmission method belongs to the target transmission method may be determined, and whether the terminal needs to determine the actually used method for reporting the amplitude coefficient is further determined.

In the method for reporting the amplitude coefficient provided by the embodiment of the present disclosure, the target method for reporting the amplitude coefficient is a method for reporting the amplitude coefficient that must be supported by the terminal in a case where the terminal supports the target transmission method; and/or the target method for reporting the amplitude coefficient is the method for reporting the amplitude coefficient that is optionally supported by the terminal.

In an example, the method for transmitting the amplitude coefficient that must be supported by the terminal in a case where the terminal supports the target transmission method is the method 1 for reporting the amplitude coefficient, and the method for reporting the amplitude coefficient that is optionally supported by the terminal is the method 2 for reporting the amplitude coefficient. The terminal needs to report capability information to the network device, and inform the network device through the capability information that it supports the method 2 for reporting the amplitude coefficient. Then, the target method for reporting the amplitude coefficient actually used by the terminal may be the method 1 for reporting the amplitude coefficient or the method 2 for reporting the amplitude coefficient.

In another example, the method for transmitting the amplitude coefficient that must be supported by the terminal in a case where the terminal supports the target transmission method is the method 2 for reporting the amplitude coefficient, and the method for reporting the amplitude coefficient that is optionally supported by the terminal is the method 1 for reporting the amplitude coefficient. The terminal needs to report capability information to the network device, and inform the network device through the capability information that it supports the method 1 for reporting the amplitude coefficient. Then, the target method for reporting the amplitude coefficient actually used by the terminal may be the method 1 for reporting the amplitude coefficient or the method 2 for reporting the amplitude coefficient. In the method for reporting the amplitude coefficient provided by the embodiment of the present disclosure, the target method for reporting the amplitude coefficient includes at least one of: A. two groups of amplitude coefficients are reported, where the first group of amplitude coefficients includes amplitude coefficients in a first polarization direction, where the second group of amplitude coefficients includes amplitude coefficients in a second polarization direction, and where the first polarization direction corresponds to a polarization direction where a strongest amplitude coefficient is located; or B. 2N groups of amplitude coefficients are reported, where N is the number of NZP CSI-RSs included in the CMR, where each NZP CSI-RS corresponds to two groups of amplitude coefficients corresponding to different polarization directions, and where N is a positive integer.

In an example, in a case where target amplitude coefficient reporting includes the method A, in this case, the strongest amplitude coefficient in the polarization direction where the strongest coefficient indicator (SCI) is located defaults to be 1, the terminal does not need to report the amplitude coefficient, and the terminal merely needs to report amplitude coefficients at other locations in the polarization direction, where the amplitude coefficients at other locations are differential values from 1. The terminal independently reports a reference amplitude in another polarization direction and reports amplitude coefficients at other locations in the other polarization direction, where the amplitude coefficients at other locations are differential values from the reference amplitude in the another polarization direction.

In another example, in a case where the target amplitude coefficient reporting includes the method B, in this case, the strongest amplitude coefficient within a group where the SCI is located defaults to be 1, the terminal does not need to report the amplitude coefficient, and the terminal merely needs to report amplitude coefficients at other locations within this group, where the amplitude coefficients at other locations are differential values from 1. For other 2N−1 groups, the terminal reports one reference amplitude for each group and reports the amplitude coefficients at other locations within this group, where the amplitude coefficients at other locations are differential values from the reference amplitude in the polarization direction.

In the embodiment of the present disclosure, compared with the method A, the method B needs to additionally report 2N−2 reference amplitudes, so in a case where N is greater than 1, signaling overheads of the method B are relatively higher, that is, the size of the CSI second information corresponding to the method B is larger.

In the embodiment of the present disclosure, in a case where the target method for reporting the amplitude coefficient is the method A, since the terminal merely needs to report two groups of amplitude coefficients, CSI signaling consumption can be reduced when the terminal reports a target amplitude coefficient through the CSI.

It is to be noted that those skilled in the art can understand that the various mentioned implementations/embodiments of the embodiments of the present disclosure can be used in conjunction with the aforementioned embodiments or independently. Whether to be used alone or together with the aforementioned embodiments, its implementation principle is similar. In the embodiment of the present disclosure, part of the embodiments is illustrated through the implementation used together. Certainly, those skilled in the art can understand that such examples do not limit the embodiments of the present disclosure.

Based on the same concept, an embodiment of the present disclosure further provides a device for reporting an amplitude coefficient.

It may be understood that, in order to implement the functions, the device for reporting the amplitude coefficient provided by the embodiment of the present disclosure includes corresponding hardware structures and/or software modules for performing all the functions. Combining with units and algorithm steps of each example disclosed in the embodiment of the present disclosure, the embodiment of the present disclosure can be implemented in a form of hardware or a combination of hardware and computer software. Whether a certain function is performed in a mode of hardware or a mode of the hardware driven by the computer software depends on a specific application and design constraint conditions of the technical solution. Those skilled in the art may use different methods to implement the described functions for each specific application, but such implementation should not be regarded beyond the scope of the technical solution of the embodiment of the present disclosure.

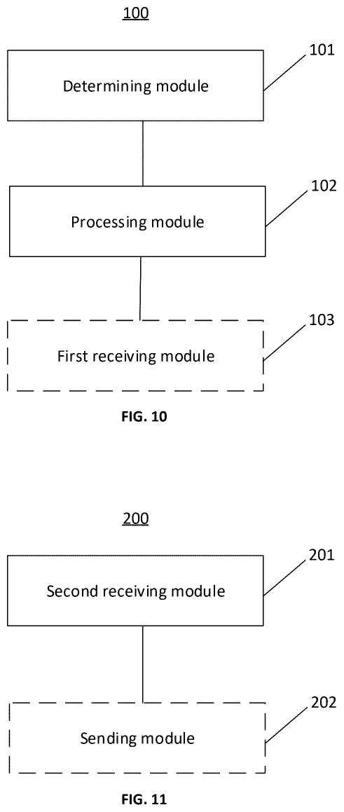

FIG. 10 is a block diagram of a device for reporting an amplitude coefficient 100 shown according to an example. Referring to FIG. 10, the device 100 includes a determining module 101 and a processing module 102. The device for reporting the amplitude coefficient 100 is applied to a terminal.

The determining module 101 is configured to determine a target method for reporting the amplitude coefficient in a case where at least two methods for reporting the amplitude coefficient are supported. The processing module 102 is configured to report the amplitude coefficient to a network device based on the target method for reporting the amplitude coefficient.

In an implementation, the device for reporting the amplitude coefficient 100 further includes a first receiving module 103. The first receiving module 103 is configured to receive first indication information sent by a network device, where the first indication information is configured to indicate a first method for reporting an amplitude coefficient.

The determining module 101 is configured to determine the first method for reporting the amplitude coefficient as the target method for reporting the amplitude coefficient based on the first indication information.

In an implementation, the first indication information is further configured to indicate at least one CMR corresponding to the first method for reporting the amplitude coefficient.

In an implementation, the determining module 101 is configured to determine the target method for reporting the amplitude coefficient, and send second indication information to the network device, where the second indication information is configured to indicate the target method for reporting the amplitude coefficient.

In an implementation, the first receiving module 103 is configured to receive third indication information from the network device, where the third indication information is configured to enable the terminal to report the second indication information.

In an implementation, the second indication information is carried in channel state information (CSI).

In an implementation, the CSI includes: first information and second information, where the first information corresponds to an indication field with a fixed size, where a size of an indication field corresponding to the second information is determined based on the first information; and where the second indication information is carried in the first information.

In an implementation, the first information further includes at least one of: a channel state information reference signal resource indicator (CRI); rank indication information; NZP CSI-RS selection information; a broadband channel quality indicator (CQI); a number of non-zero broadband amplitude coefficients; indication information of a number of non-zero coefficients; indication information of a location of a non-zero coefficient; or mode indication information.

In an implementation, the second information includes precoding matrix indicator (PMI) information. Where the PMI information includes at least one of: parameter information of a spatial domain basis vector; parameter information of a frequency domain basis vector; the indication information of the location of the non-zero coefficient; phase coefficient information; or amplitude coefficient information.

In an implementation, the determining module 101 is further configured to determine a transmission method of a physical downlink shared channel (PDSCH) performed by the terminal as a target transmission method.

In an implementation, the target transmission method meets at least one of: each CMR in the at least one CMR includes at least one NZP CSI-RS resource; the terminal reports parameter information of a spatial domain basis vector respectively for each NZP CSI-RS resource; the terminal reports parameter information of a frequency domain basis vector respectively for each NZP CSI-RS resource; the terminal reports the parameter information of the frequency domain basis vector respectively for each CMR; each NZP CSI-RS resource corresponds to a TRP; or a number of TCI states corresponding to PDSCH transmission is at least one.

In an implementation, the target method for reporting the amplitude coefficient is a method for reporting the amplitude coefficient that must be supported by the terminal in a case where the terminal supports the target transmission method; and/or the target method for reporting the amplitude coefficient is a method for reporting the amplitude coefficient that is optionally supported by the terminal.

In an implementation, the target method for reporting the amplitude coefficient includes at least one of: two groups of amplitude coefficients are reported, where a first group of amplitude coefficients includes amplitude coefficients in a first polarization direction, where a second group of amplitude coefficients includes amplitude coefficients in a second polarization direction, and where the first polarization direction corresponds to a polarization direction where a strongest amplitude coefficient is located; or 2N groups of amplitude coefficients are reported, where N is a number of NZP CSI-RSs included in a CMR, where each NZP CSI-RS corresponds to two groups of amplitude coefficients corresponding to different polarization directions, and where N is a positive integer.

As for the device in the embodiments, the specific manners for performing operations by each module have been described in the embodiments related to the method in detail, which is not illustrated in detail here.

FIG. 11 is a block diagram of a device for reporting an amplitude coefficient 200 shown according to an example. Referring to FIG. 11, the device 200 includes a second receiving module 201. The device for reporting the amplitude coefficient 200 is applied to a network device.

The second receiving module 201 is configured to receive the amplitude coefficient reported by a terminal based on a target method for reporting the amplitude coefficient.

In an implementation, the device for reporting the amplitude coefficient 200 further includes a sending module 202, and the sending module 202 is configured to send first indication information to the terminal. Where the first indication information is configured to indicate a first method for reporting the amplitude coefficient, and where the first method for reporting the amplitude coefficient is the target method for reporting the amplitude coefficient of the terminal.

In an implementation, the first indication information is further configured to indicate at least one CMR corresponding to the first method for reporting the amplitude coefficient.

In an implementation, the second receiving module 201 is configured to receive second indication information sent by the terminal, where the second indication information is configured to indicate the target method for reporting the amplitude coefficient of the terminal.

In an implementation, the sending module 202 is configured to send third indication information to the terminal, where the third indication information is configured to enable the terminal to report the second indication information.

In an implementation, the second indication information is carried in channel state information (CSI).

In an implementation, the CSI includes: first information and second information, where the first information corresponds to an indication field with a fixed size, where a size of an indication field corresponding to the second information is determined based on the first information; and where the second indication information is carried in the first information.

In an implementation, the first information further includes at least one of: a channel state information reference signal resource indicator (CRI); rank indication information; NZP CSI-RS selection information; a broadband channel quality indicator (CQI); a number of non-zero broadband amplitude coefficients; indication information of a number of non-zero coefficients; indication information of a location of a non-zero coefficient; or mode indication information.

In an implementation, the second information includes precoding matrix indicator (PMI) information. The PMI information includes at least one of: parameter information of a spatial domain basis vector; parameter information of a frequency domain basis vector; the indication information of the location of the non-zero coefficient; phase coefficient information; or amplitude coefficient information.

In an implementation, a method for the terminal to receive a physical downlink shared channel is a target transmission method. In an implementation, the target transmission method meets at least one of: each CMR in the at least one CMR includes at least one NZP CSI-RS resource; the terminal reports parameter information of a spatial domain basis vector respectively for each NZP CSI-RS resource; the terminal reports parameter information of a frequency domain basis vector respectively for each NZP CSI-RS resource; the terminal reports the parameter information of the frequency domain basis vector respectively for each CMR; each NZP CSI-RS resource corresponds to a TRP; or a number of TCI states corresponding to PDSCH transmission is at least one.

In an implementation, the target method for reporting the amplitude coefficient is a method for reporting the amplitude coefficient that must be supported by the terminal in a case where the terminal supports the target transmission method; and/or the target method for reporting the amplitude coefficient is a method for reporting the amplitude coefficient that is optionally supported by the terminal.

In an implementation, the target method for reporting the amplitude coefficient includes at least one of: two groups of amplitude coefficients are reported, where a first group of amplitude coefficients includes amplitude coefficients in a first polarization direction, where a second group of amplitude coefficients includes amplitude coefficients in a second polarization direction, and where the first polarization direction corresponds to a polarization direction where a strongest amplitude coefficient is located; or 2N groups of amplitude coefficients are reported, where N is a number of NZP CSI-RSs included in a CMR, where each NZP CSI-RS corresponds to two groups of amplitude coefficients corresponding to different polarization directions, and where N is a positive integer.

As for the device in the embodiments, the specific manners for performing operations by each module have been described in the embodiments related to the method in detail, which is not illustrated in detail here.

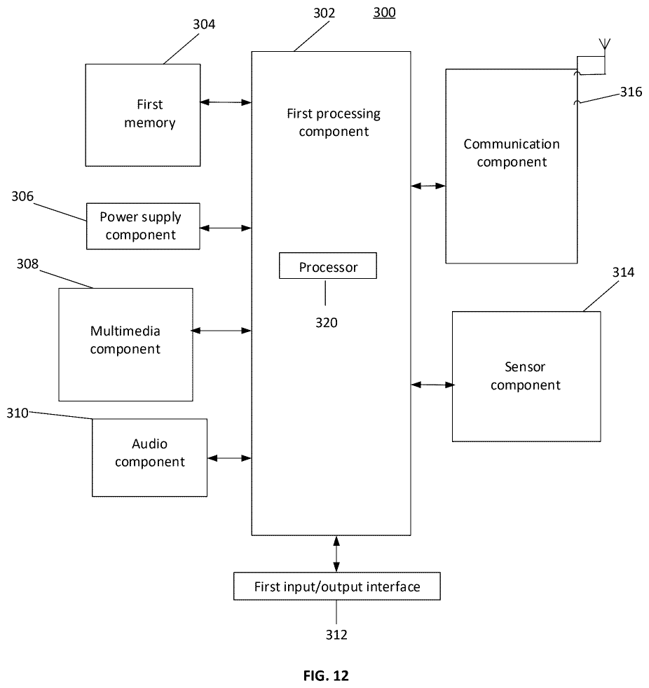

FIG. 12 is a block diagram of a communication device 300 shown according to an example. For example, the device 300 may be a mobile telephone, a computer, a digital broadcast terminal, a message transceiving device, a game console, a tablet device, a medical device, a fitness device, a personal digital assistant, and the like.

Referring to FIG. 12, the device 300 may include one or more of the following components: a first processing component 302, a first memory 304, a power supply/electrical component 306, a multimedia component 308, an audio component 310, a first input/output (I/O) interface 312, a sensor component 314, and a communication component 316.

The first processing component 302 usually controls an overall operation of the device 300, such as operations associated with displaying, telephone calling, data communication, a camera operation and a record operation. The first processing component 302 may include one or more processors 320 to execute an instruction, so as to complete all or part of steps of any of the methods. In addition, the first processing component 302 may include one or more modules, so as to facilitate interaction between the first processing component 302 and other components. For example, the first processing component 302 may include a multimedia module, so as to facilitate interaction between the multimedia component 308 and the first processing component 302.

The first memory 304 is configured to store various types of data so as to support operations on the device 300. Examples of these data include instructions of any application program or method configured to be operated on the device 300, contact data, telephone directory data, messages, pictures, videos, and the like. The first memory 304 may be implemented by any type of volatile or nonvolatile storage device or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply/electrical component 306 provides electric power for various components of the device 300. The power supply/electrical component 306 may include a power management system, one or more power sources, and other components associated with generating, managing and distributing electric power for the device 300.

The multimedia component 308 includes a screen providing an output interface between the device 300 and a user. In some embodiments, the screen may include a liquid crystal display (LCD) and a touch panel (TP). In response to determining that the screen includes the touch panel, the screen may be implemented as a touch screen so as to receive an input signal from the user. The touch panel includes one or more touch sensors to sense touching, swiping and gestures on the touch panel. The touch sensor may not only sense a boundary of a touching or swiping action, but also detect duration and pressure related to the touching or swiping operation. In some embodiments, the multimedia component 308 includes a front camera and/or a back camera. In response to determining that the device 300 is in an operation mode, such as a shooting mode or a video mode, the front camera and/or the back camera may receive external multimedia data. Each front camera and each back camera may be a fixed optical lens system or have a focal length and optical zooming capability.

The audio component 310 is configured to output and/or input an audio signal. For example, the audio component 310 includes a microphone (MIC). When the device 300 is in an operation mode, such as a call mode, a recording mode or a speech recognition mode, the microphone is configured to receive an external audio signal. The received audio signal may be further stored in the first memory 304 or sent via the communication component 316. In some embodiments, the audio component 310 further includes a speaker for outputting the audio signal.

The first I/O interface 312 provides an interface between the first processing component 302 and a peripheral interface module, and the peripheral interface module may be a keyboard, a click wheel, buttons, etc. These buttons may include but are not limited to: a home button, a volume button, a start button and a lock button.

The sensor component 314 includes one or more sensors for providing state evaluations of all aspects for the device 300. For example, the sensor component 314 may detect an on/off state of the device 300 and relative positioning of components, for example, the components are a display and a keypad of the device 300. The sensor component 314 may further detect location change of the device 300 or one component of the device 300, whether there is contact between the user and the device 300, azimuth or speed up/speed down of the device 300, and temperature change of the device 300. The sensor component 314 may include a proximity sensor, which is configured to detect existence of a nearby object without any physical contact. The sensor component 314 may further include an optical sensor, such as a CMOS or CCD image sensor, for use in an imaging application. In some embodiments, the sensor component 314 may further include an acceleration sensor, a gyroscope sensor, a magnetic sensor, a pressure sensor or a temperature sensor.

The communication component 316 is configured to facilitate wired or wireless communication between the device 300 and other devices. The device 300 may access a wireless network based on a communication standard, such as WiFi, 2G or 3G, or their combination. In an example, the communication component 316 receives a broadcast signal or broadcast related information from an external broadcast management system via a broadcast channel. In an example, the communication component 316 further includes a near-field communication (NFC) module so as to facilitate short-range communication. For example, the NFC module may be implemented based on a radio frequency identification (RFID) technology, an infrared data association (IrDA) technology, an ultra wide band (UWB) technology, a Bluetooth (BT) technology and other technologies.

In the example, the device 300 may be implemented by one or more application specific integrated circuits (ASICs), digital signal processors (DSPs), digital signal processing devices (DSPDs), programmable logic devices (PLDs), field-programmable gate arrays (FPGAs), controllers, microcontrollers, microprocessors or other electronic elements for performing any of the methods.

In the example, a non-transitory computer readable storage medium including instructions is further provided, such as a first memory 304 including instructions. The instructions may be executed by a processor 320 of the device 300 so as to complete any of the methods. For example, the non-transitory computer readable storage medium may be an ROM, a random access memory (RAM), a CD-ROM, a magnetic tape, a floppy disk, an optical data storage device and the like.

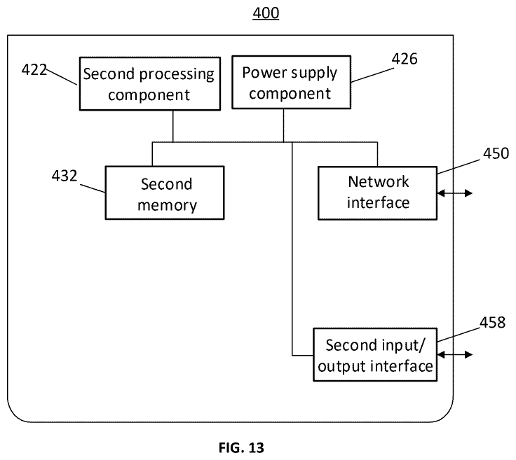

FIG. 13 is a block diagram of a communication device 400 shown according to an example. For example, the device 400 may be provided as a network device. Referring to FIG. 13, the device 400 includes a second processing component 422, which further includes one or more processors (not shown), and a memory resource represented by a second memory 432, for storing instructions executable by the second processing component 422, such as an application program. The application program stored in the second memory 432 may include one or more modules with each corresponding to a set of instructions. In addition, the second processing component 422 is configured to execute the instructions to perform any of the methods.

The device 400 may further include a power supply component 426 configured to perform power management of the device 400, a wired or wireless network interface 450 configured to connect the device 400 to a network, and a second input/output (I/O) interface 458. The device 400 may operate based on an operating system stored in the second memory 432, such as Windows Server™, Mac OS X™, Unix™, Linux™, FreeBSD™, or the like.

In the example, a non-transitory computer-readable storage medium including instructions is further provided, such as the second memory 432 including instructions. The instructions may be executed by the second processing component 422 of the device 400 so as to complete any of the methods. For example, the non-transitory computer readable storage medium may be an ROM, a random access memory (RAM), a CD-ROM, a magnetic tape, a floppy disk, an optical data storage device and the like.

As used herein, the term processor may refer to one processor that performs the defined functions or a plurality of processors that collectively perform defined functions, so that the execution of the individual defined functions may be divided amongst such processors.

It may be further understood that in the present disclosure, “a plurality of” refers to two or more than two, and other quantifiers are similar. “And/or” describes an association relationship of an association object, and represents that there may be three kinds of relationships, for example, A and/or B, may represent: A exists alone, A and B exist at the same time, and B exists alone. A character “/” generally represents that the previous and next association objects are in an “or” relationship. The singular forms “a”, “the” and “this” are intended to include the plural forms as well, unless the context clearly indicates otherwise.

It may be further understood that the meanings of words such as “in response to” and “if” mentioned in the present disclosure depend on the context and the actual usage scenario. For example, the word “in response to” used here may be interpreted as “when” or “while” or “if” or “in case of”.

It may be further understood that the terms “first”, “second” and the like are used to describe various information, but these information needs not be limited to these terms. These terms are merely configured to distinguish the same type of information from one another, and do not imply a particular order or a level of importance. In fact, the expressions “first”, “second” and the like may be used completely interchangeably. For example, in a case of not departing from the scope of the present disclosure, first information may also be referred to as second information, and similarly, the second information may also be referred to as the first information.

It may be further understood that although in the embodiments of the present disclosure, the operations are described in a specific order in the accompanying drawings, it needs not be construed as requiring that the operations are performed in the specific order shown or a serial order, or that all the operations shown are performed to obtain desired results. In a certain circumstance, multitasking and parallel processing may be advantageous.

Those skilled in the art will easily figure out other implementation solutions of the present disclosure after considering the specification and practicing the invention disclosed here. The present application intends to cover any transformation, usage or adaptive change of the present disclosure, and these transformations, usages or adaptive changes conform to a general principle of the present disclosure and include common general knowledge or conventional technical means in the technical field not disclosed by the present disclosure.

It is to be understood that the present disclosure is not limited to the exact structure that has been described and shown in the accompanying drawings, and that various modifications and changes may be made without departing from the scope of the present disclosure. The scope of the present disclosure is limited merely by the scope of the appended claims.

1. A method for reporting an amplitude coefficient, performed by a terminal, comprising:
determining a target method for reporting the amplitude coefficient in a case where at least two methods for reporting the amplitude coefficient are supported; and
reporting the amplitude coefficient to a network device based on the target method for reporting the amplitude coefficient.

2. The method according to claim 1, wherein determining the target method for reporting the amplitude coefficient comprises:
receiving first indication information sent by the network device, wherein the first indication information is configured to indicate a first method for reporting the amplitude coefficient; and
determining the first method for reporting the amplitude coefficient as the target method for reporting the amplitude coefficient based on the first indication information, and
wherein the first indication information is further configured to indicate at least one channel measurement resource (CMR) corresponding to the first method for reporting the amplitude coefficient.

3. (canceled)

4. The method according to claim 1, wherein determining the target method for reporting the amplitude coefficient comprises:
determining the target method for reporting the amplitude coefficient; and
sending second indication information to the network device, wherein the second indication information is configured to indicate the target method for reporting the amplitude coefficient.

5. The method according to claim 4, further comprising:
receiving third indication information from the network device, wherein the third indication information is configured to enable the terminal to report the second indication information, and
wherein the second indication information is carried in channel state information (CSI).

6. (canceled)

7. The method according to claim 5, wherein the CSI comprises: first information and second information,
wherein the first information corresponds to an indication field with a fixed size,
wherein a size of an indication field corresponding to the second information is determined based on the first information, and
wherein the second indication information is carried in the first information.

8. The method according to claim 7, wherein
the first information further comprises at least one of:
a channel state information reference signal resource indicator (CRI),
rank indication information,
non-zero power (NZP) channel state information-reference signal (CSI-RS) selection information,
a broadband channel quality indicator (CQI),
a number of non-zero broadband amplitude coefficients,
indication information of a number of non-zero coefficients,
indication information of a location of a non-zero coefficient, or
mode indication information,
the second information comprises precoding matrix indicator (PMI) information, and the PMI information comprises at least one of:
parameter information of a spatial domain basis vector,
parameter information of a frequency domain basis vector,
the indication information of the location of the non-zero coefficient,
phase coefficient information, or
amplitude coefficient information.

9. (canceled)

10. The method according to claim 2, further comprising:
determining a transmission method of a physical downlink shared channel (PDSCH) performed by the terminal as a target transmission method, and
wherein the target transmission method meets at least one of:
each CMR in the at least one CMR comprises at least one non-zero power (NZP) channel state information-reference signal (CSI-RS) resource,
the terminal reports parameter information of a spatial domain basis vector respectively for each of the at least one NZP CSI-RS resource,
the terminal reports parameter information of a frequency domain basis vector respectively for each of the at least one NZP CSI-RS resource,
the terminal reports the parameter information of the frequency domain basis vector respectively for each of the at least one CMR,
each of the at least one NZP CSI-RS resource corresponds to a transmission reception point (TRP), or
a number of transmission configuration indication (TCI) states corresponding to PDSCH transmission is at least one.

11. (canceled)

12. The method according to claim 10, wherein the method further comprises at least one of:
the target method for reporting the amplitude coefficient is a method for reporting the amplitude coefficient that must be supported by the terminal in a case where the terminal supports the target transmission method; or
the target method for reporting the amplitude coefficient is a method for reporting the amplitude coefficient that is optionally supported by the terminal.

13. The method according to claim 1, wherein the target method for reporting the amplitude coefficient comprises at least one of:
reporting two groups of amplitude coefficients, wherein a first group of the two groups of amplitude coefficients comprises amplitude coefficients in a first polarization direction, wherein a second group of the two groups of amplitude coefficients comprises amplitude coefficients in a second polarization direction, and wherein the first polarization direction corresponds to a polarization direction where a strongest amplitude coefficient is located; or
reporting 2N groups of amplitude coefficients, wherein N is a number of non-zero power channel state information-reference signals (NZP CSI-RSs) comprised in a channel measurement resource (CMR), wherein each of the NZP CSI-RSs corresponds to two groups of amplitude coefficients corresponding to different polarization directions, and wherein N is a positive integer.

14. A method for reporting an amplitude coefficient, performed by a network device, comprising:
receiving the amplitude coefficient reported by a terminal based on a target method for reporting the amplitude coefficient.

15. The method according to claim 14, further comprising:
sending first indication information to the terminal, wherein the first indication information is configured to indicate a first method for reporting the amplitude coefficient,
wherein the first method for reporting the amplitude coefficient is the target method for reporting the amplitude coefficient of the terminal, and
wherein the first indication information is further configured to indicate at least one channel measurement resource (CMR) corresponding to the first method for reporting the amplitude coefficient.

16. (canceled)

17. The method according to claim 14, further comprising:
receiving second indication information sent by the terminal, wherein the second indication information is configured to indicate the target method for reporting the amplitude coefficient of the terminal.

18. The method according to claim 17, further comprising:
sending third indication information to the terminal, wherein the third indication information is configured to enable the terminal to report the second indication information, and
wherein the second indication information is carried in channel state information (CSI).

19. (canceled)

20. The method according to claim 18, wherein the CSI comprises: first information and second information,
wherein the first information corresponds to an indication field with a fixed size,
wherein a size of an indication field corresponding to the second information is determined based on the first information, and
wherein the second indication information is carried in the first information.

21. The method according to claim 20, wherein
the first information further comprises at least one of:
a channel state information reference signal resource indicator (CRI),
rank indication information,
non-zero power (NZP) channel state information-reference signal (CSI-RS) selection information,
a broadband channel quality indicator (CQI),
a number of non-zero broadband amplitude coefficients,
indication information of a number of non-zero coefficients,
indication information of a location of a non-zero coefficient, or
mode indication information, and
the second information comprises precoding matrix indicator (PMI) information, and the PMI information comprises at least one of:
parameter information of a spatial domain basis vector,
parameter information of a frequency domain basis vector,
the indication information of the location of the non-zero coefficient,
phase coefficient information, or
amplitude coefficient information.

22. (canceled)

23. The method according to claim 15, wherein a transmission method of a physical downlink shared channel (PDSCH) performed by the terminal is a target transmission method, and
wherein the target transmission method meets at least one of:
each CMR in the at least one CMR comprises at least one non-zero power (NZP) channel state information-reference signal (CSI-RS) resource,
the terminal reports parameter information of a spatial domain basis vector respectively for each of the at least one NZP CSI-RS resource,
the terminal reports parameter information of a frequency domain basis vector respectively for each of the at least one NZP CSI-RS resource,
the terminal reports the parameter information of the frequency domain basis vector respectively for each of the at least one CMR,
each of the at least one NZP CSI-RS resource corresponds to a transmission reception point (TRP), or
a number of transmission configuration indication (TCI) states corresponding to PDSCH transmission is at least one.

24. (canceled)

25. The method according to claim 23, wherein the method further comprises at least one of:
the target method for reporting the amplitude coefficient is a method for reporting the amplitude coefficient that must be supported by the terminal in a case where the terminal supports the target transmission method; or
the target method for reporting the amplitude coefficient is a method for reporting the amplitude coefficient that is optionally supported by the terminal.

26. The method according to claim 14, wherein the target method for reporting the amplitude coefficient comprises at least one of:
reporting two groups of amplitude coefficients, wherein a first group of the two groups of amplitude coefficients comprises amplitude coefficients in a first polarization direction, wherein a second group of the two groups of amplitude coefficients comprises amplitude coefficients in a second polarization direction, and wherein the first polarization direction corresponds to a polarization direction where a strongest amplitude coefficient is located; or
reporting 2N groups of amplitude coefficients, wherein N is a number of non-zero power channel state information-reference signals (NZP CSI-RSs) comprised in a channel measurement resource (CMR), wherein each of the NZP CSI-RSs corresponds to two groups of amplitude coefficients corresponding to different polarization directions, and wherein N is a positive integer.

27-28. (canceled)

29. A terminal, comprising:
one or more processors; and
a memory that stores processor-executable instructions,
wherein the one or more processors, when performing the processor-executable instructions, are collectively configured to:
determine a target method for reporting the amplitude coefficient in a case where at least two methods for reporting the amplitude coefficient are supported, and
report the amplitude coefficient to a network device based on the target method for reporting the amplitude coefficient.

30. A network device, comprising:
one or more processors; and
a memory that stores processor-executable instructions, and
wherein the one or more processors, when performing the processor-executable instructions, are collectively configured to perform the method according to claim 14.

31-33. (canceled)
